(19) United States
(12) Patent Application Publication
(10) Pub. No.: US 2023/0102970 A1
(43) Pub. Date: Mar. 30, 2023

(54) VEGETABLE PROTEIN-CONTAINING FOOD

(71) Applicant: Otsuka Foods Co., Ltd., Osaka-shi, Osaka (JP)

(72) Inventors: Kazushi Takemura, Otsu-shi, Shiga (JP); Yudai Horiuchi, Otsu-shi, Shiga (JP); Takuya Okamoto, Otsu-shi, Shiga (JP); Hiroyuki Shima, Otsu-shi, Shiga (JP)

(21) Appl. No.: 17/904,982

(22) PCT Filed: Feb. 10, 2021
(86) PCT No.: PCT/JP2021/005085

§ 371 Date: Aug. 25, 2022

(30) Foreign Application Priority Data
Feb. 27, 2020 (JP) 2020-031792

(51) Int. Cl. A23J 3/16; A23J 3/22

(52) U.S. Cl. CPC A23J 3/16; A23J 3/227

(57) ABSTRACT

The purpose of the present invention is to provide a vegetable protein-containing food that has an excellent juicy feeling (juiciness), a meat-like hardness, a good chewiness and almost the same texture as a natural livestock meat-containing food. A vegetable protein-containing food that comprises (A) a granular vegetable protein, and/or a granular textured vegetable protein containing brown rice, (B) a fibrillated granular vegetable protein, and (C) a mixture of oil or fat, water and methyl cellulose. This vegetable protein-containing food has an excellent juicy feeling (juiciness), a meat-like hardness, a good chewiness and almost the same texture as a natural livestock meat-containing food, which makes it appropriately usable as a pseudo-meat food.

### TECHNICAL FIELD

The present invention relates to a vegetable protein-containing food that has excellent juicy feeling (juiciness), good hardness and chewiness, and a texture close to that of a natural livestock meat-containing food.

### BACKGROUND ART

In recent years, a demand for vegetable protein-containing foods processed using vegetable proteins such as soybean proteins has been increasing. It has been known that, in a vegetable protein-containing food, by using a vegetable protein processed into a fibrous tissue, a texture similar to that of a natural livestock meat can be imparted, and the vegetable protein-containing food can be used as an alternative to meat. Conventionally, as a method for texturizing proteins, a method using a biaxial extruder is mainly used, and for example, those processed by this method are distributed as a textured soybean protein, a granular soybean protein, and the like. However, when the textured soybean protein or the granular soybean protein is simply used singly, there is a limit to bringing the texture close to that of the natural livestock meat, and it is particularly difficult to sufficiently exhibit the juicy feeling.

Conventionally, various techniques for improving the texture of a pseudo-meat food (meat-like food) using a vegetable protein have been studied. For example, Patent Document 1 discloses that a processed food having a texture and flavor similar to those of a natural livestock meat is obtained by humidity-controlling and mixing two specific textured protein-containing materials at a predetermined amount ratio, molding the mixture, heating and binding the mixture by microwave irradiation, then returning the mixture with boiling water in a seasoning liquid, and further baking the resultant mixture. Patent Document 2 discloses that a textured vegetable protein material, which contains a vegetable protein raw material and a sugar alcohol, has a sugar alcohol content of 0.1 wt % or more in dry weight, has a puffed texture, and has a water absorption rate of 1 time or more, has a hard texture close to that of a natural livestock meat.

However, conventional pseudo-meat foods are still not satisfactory in terms of a texture or lack simplicity of operation, and thus there is room for further improvement. In recent years, with diversification and improvement of consumers preference, a pseudo-meat food in which juicy feeling is sufficiently felt is required.

### PRIOR ART DOCUMENTS

### Patent Documents

Patent Document 1: WO 2012/132917 A
Patent Document 2: Japanese Patent Laid-open Publication No. 2008-61592

### SUMMARY OF THE INVENTION

### Problems to be Solved by the Invention

An object of the present invention is to provide a vegetable protein-containing food that has excellent juicy feeling (juiciness), good hardness and chewiness, and a texture close to that of a natural livestock meat-containing food.

### Means for Solving the Problem

The present inventors have conducted intensive studies in order to solve the above problems, and as a result, have found that a vegetable protein-containing food, which contains (A) a granular vegetable protein, and/or a granular textured vegetable protein containing brown rice, (B) a fibrillated granular vegetable protein, and (C) a mixture of fat and oil, water, and methyl cellulose, has excellent juicy feeling (juiciness), good hardness and chewiness, and a texture close to that of a natural livestock meat-containing food, which makes it appropriately usable as a pseudo-meat food. The present inventors have conducted further studies based on the findings, leading to the completion of the present invention.

That is, the present invention provides inventions of the following aspects.

Item 1. A vegetable protein-containing food containing: (A) a granular vegetable protein, and/or a granular textured vegetable protein containing brown rice; (B) a fibrillated granular vegetable protein; and (C) a mixture of fat and oil, water, and methyl cellulose.
Item 2. The vegetable protein-containing food described in Item 1, in which the component (A) is a granular soybean protein, and/or a granular textured soybean protein containing brown rice, and the component (B) is a fibrillated granular soybean protein.
Item 3. The vegetable protein-containing food described in Item 1 or 2, in which the component (A) includes both the granular vegetable protein and the granular textured vegetable protein containing brown rice.
Item 4. The vegetable protein-containing food described in Item 3, in which the granular textured vegetable protein containing brown rice is contained in an amount of 100 to 1900 parts by weight in terms of dry solid content per 100 parts by weight of the granular vegetable protein in terms of dry solid content.
Item 5. The vegetable protein-containing food described in any one of Items 1 to 4, in which the component (C) is a mixture of 5 to 50 parts by weight of fat and oil, 30 to 92 parts by weight of water, and 3 to 20 parts by weight per 100 parts by weight of a total amount of fat and oil, water, and methyl cellulose.
Item 6. The vegetable protein-containing food described in any one of Items 1 to 5, in which the component (A) is contained in an amount of 5 to 25 wt % in terms of dry solid content, the component (B) is contained in an amount of 1 to 10 wt % in terms of dry solid content, and the component (C) is contained in an amount of 10 to 80 wt %.
Item 7. The vegetable protein-containing food described in any one of Items 1 to 6, in which the vegetable protein-containing food is a hamburger steak-like food.
Item 8. A method for producing a vegetable protein-containing food, the method including:

a step of obtaining a mixture that contains (A) a granular vegetable protein, and/or a granular textured vegetable protein containing brown rice, (B) a fibrillated granular vegetable protein, and (C) a mixture of fat and oil, water, and methyl cellulose; and

a step of molding and heating the mixture.

Item 9. The method described in Item 8, in which the vegetable protein-containing food is a hamburger steak-like food.

### Advantages of the Invention

The vegetable protein-containing food of the present invention has excellent juicy feeling (juiciness), good hardness and chewiness, and a texture close to that of a natural livestock meat-containing food, which makes it useful as a pseudo-meat food.

### EMBODIMENTS OF THE INVENTION

A vegetable protein-containing food of the present invention contains (A) a granular vegetable protein, and/or a granular textured vegetable protein containing brown rice, (B) a fibrillated granular vegetable protein, and (C) a mixture of fat and oil, water, and methyl cellulose. Hereinafter, the vegetable protein-containing food of the present invention will be described in detail.

[(A) Granular Vegetable Protein, and/or Granular Textured Vegetable Protein Containing Brown Rice]

The vegetable protein-containing food of the present invention contains a granular vegetable protein, and/or a granular textured vegetable protein containing brown rice (these may be abbreviated as the component (A)).

The “granular vegetable protein” in the present invention is defined in “Japanese Agricultural Standards of Vegetable protein”. According to the “Japanese Agricultural Standards of Vegetable protein”, a “vegetable protein” is defined as a vegetable protein which is obtained by processing a powder of seed for oil production, such as soybean, or a degreased product thereof, or a cereal such as wheat (hereinafter, referred to as “main raw material”) to increase the protein content rate, and then molding the resultant product into a powder shape, a paste shape, a granular shape, or a fibrous shape by giving a function, such as gel formability or emulsifiability, or chewiness by physical action such as heating or pressurization, and has a protein content rate derived from the main raw material (a value in terms of anhydride; hereinafter, referred to as “vegetable protein content rate”) of more than 50%. According to the “Japanese Agricultural Standards of Vegetable protein”, a “granular vegetable protein” is defined as a vegetable protein which is molded in a granular or flake shape and has a meat-like tissue. The granular vegetable protein has a fibrous internal tissue having a certain directionality.

The “granular vegetable protein” can be obtained by subjecting a mixture, which contains at least a vegetable protein raw material and water, and further contains, as necessary, fat and oil, starch, a pigment, a flavor, and the like, to a heating treatment at a high pressure with an extruder, extruding the thermoplastic raw material from a die provided at the tip of a screw under normal pressure to puff the thermoplastic raw material, and drying and molding the thermoplastic raw material in a granular shape.

The origin of the vegetable protein raw material used in the production of the granular vegetable protein is not particularly limited, and for example, protein raw materials derived from soybeans such as separated soybean, concentrated soybean, and defatted soybeans; protein raw materials derived from wheats such as flour and wheat gluten may be used. Soybean-derived protein raw materials (that is, granular soybean proteins) are preferably exemplified.

The vegetable protein content rate in the granular vegetable protein may be 50 wt % or more, and is preferably 50 to 80 wt % and more preferably 50 to 70 wt %.

Regarding the grain size of the granular vegetable protein (before hydration), a weight ratio of the granular vegetable protein passing through a test sieve having an opening of 355 μm specified in JIS Z 8801-1 is preferably 10% or less. As an embodiment of the granular vegetable protein (before hydration), the granular vegetable protein may be in a flake shape, and more specifically, the granular vegetable protein may be in a flake shape having a thickness of about 0.2 to 10.0 mm and a major diameter of about 3.0 to 20.0 mm.

In the present invention, the “granular textured vegetable protein containing brown rice” refers to a protein obtained by processing a mixture, which contains a vegetable protein raw material and granulated brown rice, to have a fibrous internal tissue having a certain directionality.

The granular textured vegetable protein containing brown rice can be obtained by subjecting a mixture, which contains at least a vegetable protein raw material, powdered brown rice, and water, and further contains, as necessary, fat and oil, starch, a pigment, a flavor, and the like, to a heating treatment at a high pressure with an extruder, extruding the thermoplastic raw material from a die provided at the tip of a screw under normal pressure to puff the thermoplastic raw material, and drying and molding the thermoplastic raw material in a granular shape.

The origin of the vegetable protein raw material used in the production of the granular textured vegetable protein containing brown rice is not particularly limited, and for example, protein raw materials derived from soybeans such as separated soybean, concentrated soybean, and defatted soybeans; protein raw materials derived from wheats such as flour and wheat gluten may be used. Soybean-derived protein raw materials are preferably exemplified.

The protein content in the granular textured vegetable protein containing brown rice is not particularly limited, and the protein content is, for example, 40 to 80 parts by weight, preferably 45 to 65 parts by weight, and more preferably 50 to 55 parts by weight per 100 parts by weight of the total amount of the granular textured vegetable protein containing brown rice.

The brown rice content in the granular textured vegetable protein containing brown rice is not particularly limited, and the brown rice content is, for example, 3 to 15 parts by weight, preferably 3 to 10 parts by weight, and more preferably 3 to 8 parts by weight per 100 parts by weight of the total amount of the granular textured vegetable protein containing brown rice.

Regarding the grain size of the granular textured vegetable protein containing brown rice (before hydration), a weight ratio of the granular textured vegetable protein containing brown rice passing through a test sieve having an opening of 355 μm specified in JIS Z 8801-1 is preferably 10% or less. As an embodiment of the granular textured vegetable protein containing brown rice (before hydration), the granular textured vegetable protein containing brown rice may be in a columnar shape, and more specifically, the granular textured vegetable protein containing brown rice may be in a columnar shape having a thickness of about 2.0 to 4.0 mm and a length of about 5.0 to 15.0 mm.

In the vegetable protein-containing food of the present invention, the granular vegetable protein and/or the granular textured vegetable protein containing brown rice are preferably used in a hydrated (water-containing) state. The hydration can be performed by immersing the granular vegetable protein and/or the granulated vegetable tissue protein containing brown rice in a dry state in water or oil. The moisture content in the granular vegetable protein and/or the granular textured vegetable protein containing brown rice in a hydrated state is not particularly limited, and the moisture content is, for example, 100 to 400 parts by weight, preferably 100 to 250 parts by weight, and more preferably 120 to 180 parts by weight per 100 parts by weight of the granular vegetable protein and/or the granular textured vegetable protein containing brown rice in terms of dry solid content.

In the vegetable protein-containing food of the present invention, as the component (A), any one of the granular vegetable protein and the granular textured vegetable protein containing brown rice may be used singly or these proteins may be used in combination.

From the viewpoint of suitably providing excellent juicy feeling and good hardness and chewiness in a well-balanced manner, as the component (A), the granular vegetable protein and the granular textured vegetable protein containing brown rice are preferably used in combination. In the case of using the granular vegetable protein and the granular textured vegetable protein containing brown rice in combination, the ratio of these proteins are not particularly limited, and the ratio of the granular textured vegetable protein containing brown rice is, for example, 100 to 1900 parts by weight, preferably 150 to 1900 parts by weight, and more preferably 300 to 1900 parts by weight in terms of dry solid content per 100 parts by weight of the granular vegetable protein in terms of dry solid content.

In the vegetable protein-containing food of the present invention, the content of the component (A) may be appropriately set depending on the type of the vegetable protein-containing food, and the like, and the content of the component (A) is, for example, 5 to 25 wt %, preferably 10 to 20 wt %, and more preferably 12 to 18 wt % in terms of dry solid content.

### [(B) Fibrillated Granular Vegetable Protein]

The vegetable protein-containing food of the present invention contains a fibrillated granular vegetable protein (this may be abbreviated as the component (B)).

In the present invention, the “fibrillated granular vegetable protein” is a fibrous product obtained by fibrillating a granular vegetable protein.

The type of the granular vegetable protein serving as a raw material for the fibrillated granular vegetable protein, the vegetable protein content rate, preferred embodiments, and the like are the same as those in the case of the granular vegetable protein to be used as the component (A).

The fibrillated granular vegetable protein can be obtained by fibrillating a granular vegetable protein in a fibrous product with a food cutter or the like in a state of being hydrated (containing water) by adding water.

The shape of the fibrillated granular vegetable protein is, for example, in a hydrated state, a shape having a length of about 1 to 35 mm and a thickness of about 0.01 to 1 mm; preferably a shape having a length of about 1 to 30 mm and a thickness of about 0.01 to 0.8 mm; and more preferably a shape having a length of about 3 to 20 mm and a thickness of about 0.03 to 0.5 mm.

In the vegetable protein-containing food of the present invention, the fibrillated granular vegetable protein is preferably used in a hydrated (water-containing) state. The moisture content in the fibrillated granular vegetable protein in a hydrated state is not particularly limited, and the moisture content is, for example, 100 to 400 parts by weight, preferably 120 to 300 parts by weight, and more preferably 130 to 270 parts by weight per 100 parts by weight of the fibrillated granular vegetable protein in terms of dry solid content.

In the vegetable protein-containing food of the present invention, as for the ratio of the component (A) and the component (B), the ratio of the component (B) is, for example, 10 to 60 parts by weight, preferably 20 to 50 parts by weight, and more preferably 30 to 40 parts by weight in terms of dry solid content per 100 parts by weight of the total amount of the component (A) in terms of dry solid content.

In the vegetable protein-containing food of the present invention, the content of the component (B) may be appropriately set depending on the type of the vegetable protein-containing food, and the like, and the content of the component (B) is, for example, 1 to 10 wt %, preferably 3 to 8 wt %, and more preferably 4 to 6 wt % in terms of dry solid content.

### [(C) Mixture of Fat and Oil, Water, and Methyl Cellulose]

The vegetable protein-containing food of the present invention further contains a mixture of fat and oil, water, and methyl cellulose (this may be abbreviated as the component (C)). This mixture plays a role of settling the component (A) and the component (B) and also plays a role of exhibiting excellent juicy feeling.

The type of the fat and oil is not particularly limited as long as it can be used for food, and examples thereof include vegetable fats and oils such as palm olein, palm oil, coconut oil, cocoa butter, soybean oil, cottonseed oil, corn oil, sesame oil, olive oil, wheat germ oil, rice oil, safflower oil, rapeseed oil, sunflower oil, and peanut oil; and animal fats such as beef tallow, lard, chicken fat, and butter. These fats and oils may be used singly or in combination of two or more kinds thereof. Among these, vegetable fats and oils are preferred, and vegetable fats and oils having a melting point close to that of animal fats and oils (specifically, palm olein, palm oil, coconut oil, cocoa butter, and the like) are more preferred.

The content of methoxy group in methyl cellulose is not particularly limited as long as it can be used for food, and is, for example, 22 to 33%, preferably 25 to 33%, and more preferably 28 to 33%. In the present invention, the content of methoxy group in methyl cellulose is a value measured according to the method described in Japan's Specifications and Standards for Food Additives, 9th Edition (Ministry of Health, Labour and Welfare).

Suitable examples of the methyl cellulose used in the present invention include those having a high gel strength. Methyl cellulose having a high gel strength is described, for example, in Japanese Patent Laid-open Publication Nos. 2015-71779, 2015-120911, 2012-97269, 2012-92347, Japanese Translation of PCT International Application Publication No. 2002-541270, and the like, and methyl cellulose described in these publications can be suitably used.

As for the ratios of fat and oil, water, and methyl cellulose, for example, per 100 parts by weight of the total amount of fat and oil, water, and methyl cellulose, the ratios of fat and oil, water, and methyl cellulose are 5 to 50 parts by weight, 30 to 92 parts by weight, and 3 to 20 parts by weight, respectively; the ratios of fat and oil, water, and methyl cellulose are preferably 10 to 40 parts by weight, 45 to 87 parts by weight, and 3 to 15 parts by weight, respectively; and the ratios of fat and oil, water, and methyl cellulose are more preferably 10 to 30 parts by weight, 55 to 87 parts by weight, and 3 to 15 parts by weight, respectively.

The mixture of fat and oil, water, and methyl cellulose is obtained by uniformly mixing fat and oil, water, and methyl cellulose, and a preferred embodiment thereof is an emulsion form.

In the vegetable protein-containing food of the present invention, the content of the component (C) may be appropriately set depending on the type of the vegetable protein-containing food, and the like, and the content of the component (C) is, for example, 10 to 80 wt %, preferably 10 to 50 wt %, and more preferably 15 to 25 wt %.

### [Other Components]

The vegetable protein-containing food of the present invention may contain auxiliary raw materials such as other food materials and seasoning as necessary, in addition to the components (A) to (C). Examples of such auxiliary raw materials include vegetables such as onion, carrot, burdock, potato, and sesame; cereals such as bread crumbs, flour, dogtooth violet starch, and oatmeal; seaweeds such as brown seaweed and edible brown algae; starch, egg yolk, egg white, soy sauce, sweet sake, dietary salt, spices, acidulants, fruit juice, flesh, yeast extract, meat extract, sweeteners, vegetable oils, animal fats, thickeners, pigments, flavors, antioxidants, and water.

The vegetable protein-containing food of the present invention preferably does not contain a natural livestock meat, but may contain a natural livestock meat as necessary.

### [Producing Method]

The vegetable protein-containing food of the present invention is produced by mixing the components (A) to (C) and a predetermined amount of other components to be blended as necessary to produce a mixture, molding the obtained mixture into a desired shape, and then heating the molded mixture. Heating can be performed by a method such as baking heating, steaming heating, boiling heating, frying heating, or electromagnetic wave heating. The vegetable protein-containing food of the present invention may be provided after being heated, or may be provided in a mixture form and heated in a food factory, a restaurant, home, or the like.

### [Shape, Form, and Others]

The shape of the vegetable protein-containing food of the present invention may be appropriately set depending on a target food form, and examples thereof include a block shape, a flat shape, a thick-cut shape, a sliced shape, and a minced shape.

Since the vegetable protein-containing food of the present invention has excellent juicy feeling (juiciness) and good hardness and chewiness and a texture close to that of a natural livestock meat-containing food can be achieved, the vegetable protein-containing food of the present invention can be provided as a pseudo-meat food imitating a meat processed food such as meat for hamburger steak, meat ball, steak, or stewed dish (curry, stew, or the like). In particular, in an embodiment of the vegetable protein-containing food of the present invention, juicy feeling and a texture that are close to those of a hamburger steak can be achieved, and thus the vegetable protein-containing food of the present invention is particularly suitable as a hamburger steak-like food (food imitating a hamburger steak).

### EXAMPLES

Hereinafter, the present invention will be described in more detail by means of Examples; however, the present invention is not limited to these Examples.

### 1. Production of Hamburger Steak-Like Food

### Example 1

A granular textured soybean protein containing brown rice (“Veggie minced soybeans and brown rice”, Maisen Fine Food Co., Ltd.; containing 5 wt % of brown rice and 50.6 wt % of protein; columnar shape having a diameter of 2.5 to 3.5 mm and a length of 7.0 to 15.0 mm) was added into a boiling water to be hydrated, thereby obtaining a granular textured soybean protein containing brown rice having a moisture content of 60.0 mass %. A granular soybean protein (“GS52-2-10”, GUSHEN JAPAN LIMITED; containing 65.0 wt % of protein; flake shape having a thickness of 2.0 to 8.0 mm and a diameter of 3.0 to 17.0 mm) was added to water to be hydrated, thereby obtaining a granular soybean protein having a moisture content of 66.7 mass %. Separately, a granular soybean protein (“APEX 950”, manufactured by FUJI OIL CO., LTD.; containing 63.0 wt % of protein) was added to water to be hydrated and then fibrillated using a food cutter, thereby obtaining a fibrillated granular vegetable protein having a moisture content of 60.0 mass %. The fibrillated granular vegetable protein thus obtained had a length of about 3 to 20 mm and a thickness of about 0.03 to 0.5 mm.

An emulsion mixture (mixture of methyl cellulose, vegetable oil, and water) was obtained by mixing 5 wt % of methyl cellulose (“Methocel Bind112”, manufactured by DowDuPont; content of methoxy group: 30.6%), 20 wt % of vegetable oil (palm olein; “MULTI ACE 20”, manufactured by The Nisshin OilliO Group, Ltd.), and 75 wt % of cold water and stirring the resultant product with a food cutter.

A predetermined amount of other auxiliary raw materials were mixed and kneaded together with the granular textured vegetable protein containing brown rice, the granular soybean protein, the fibrillated granular vegetable protein, and the mixture of methyl cellulose, vegetable oil, and water obtained as described above so as to have the composition shown in Table 1, thereby obtaining a mixture. A hamburger steak-like food was produced by molding 100 g (flat shape of about 90 mm×about 60 mm×about 24 mm) of the obtained mixture and subjecting the molded mixture to baking heating with a frying pan.

### Example 21

A hamburger steak-like food was produced under the same conditions as in Example 1, except that the granular textured soybean protein containing brown rice was not blended, and the composition was changed to the composition shown in Table 1.

### Example 3

A hamburger steak-like food was produced under the same conditions as in Example 1, except that the granular soybean protein was not blended, and the composition was changed to the composition shown in Table 1.

### Comparative Example 1

A hamburger steak-like food was produced under the same conditions as in Example 1, except that the mixture of methyl cellulose, vegetable oil, and water was not blended, and methyl cellulose, vegetable oil, and water were separately blended.

### Comparative Example 2

A granular soybean protein (“New Fujipro SHE”, manufactured by FUJI OIL CO., LTD.) was added to cold water and stirred with a food cutter, and then stirred while gradually adding vegetable oil (palm olein; “MULTI ACE 20”, manufactured by The Nisshin OilliO Group, Ltd.) thereto, thereby obtaining a mixture of a granular soybean protein, vegetable oil, and water. The composition of the mixture is 9.5 wt % of the granular soybean protein, 19.1 wt % of the vegetable oil, and 71.4 wt % of the cold water.

A hamburger steak-like food was produced under the same conditions as in Example 1, except that a mixture of a granular soybean protein, vegetable oil, water, and egg white powder was used instead of the mixture of methyl cellulose, vegetable oil, and water, and the composition was changed to the composition shown in Table 1.

### Comparative Example 3

A hamburger steak-like food was produced under the same conditions as in Example 2, except that the mixture of methyl cellulose, vegetable oil, and water was not blended, and methyl cellulose, vegetable oil, and water were separately blended.

### Comparative Example 4

A hamburger steak-like food was produced under the same conditions as in Example 2, except that a mixture of a granular soybean protein, vegetable oil, water, and egg white powder was used instead of the mixture of methyl cellulose, vegetable oil, and water, and the composition was changed to the composition shown in Table 1.

### Comparative Example 5

A hamburger steak-like food was produced under the same conditions as in Example 3, except that the mixture of methyl cellulose, vegetable oil, and water was not blended, and methyl cellulose, vegetable oil, and water were separately blended.

### Comparative Example 6

A hamburger steak-like food was produced under the same conditions as in Example 3, except that a mixture of a granular soybean protein, vegetable oil, water, and egg white powder was used instead of the mixture of methyl cellulose, vegetable oil, and water, and the composition was changed to the composition shown in Table 1.

### 2. Evaluation Method

### [Method for Evaluating Juicy Feeling]

The hamburger steak-like food thus obtained was put in a plastic bag, vacuum-sealed, put in a water bath at 70° C., and heated for 1 hour. After the heating, the hamburger steak-like food was taken out from the plastic bag and cut into a cube of 5 mm square from the central portion. The weight (hereinafter. Weight A) of the cut sample was measured, and then the sample was sandwiched by filter paper and pressurized at 10 kg/cm² for 1 minute with a texture measuring instrument (TENSIPRESSER TTP-50BX II) using a cylindrical plunger (φ60 mm). After the pressurization, the sample was removed from the filter paper, and the weight (hereinafter, Weight B) of the juice attached to the filter paper was measured. A meat juice ratio (%) was calculated according to Equation: (Weight B/Weight A)×100

### [Method for Evaluating Hardness and Chewiness]

The hamburger steak-like food thus obtained was put in a plastic bag, vacuum-sealed, put in a water bath at 70° C., and heated for 1 hour. After the heating, the hamburger steak-like food was taken out from the plastic bag and cut into a cube of 5 mm square, and hardness and chewiness were evaluated with a texture measuring instrument (TENSIPRESSER TTP-50BX II) using a cylindrical plunger (φ5 mm) by a multiple integration bite analysis method with a pushing rate of 2 mm/sec and a pushing distance of 15 mm being set. From the obtained stress waveform, the maximum stress (gw/cm²) was evaluated as hardness, and the integral value (gw/cm²-cm) of the stress and the plunger pushing distance was evaluated as chewiness.

### 3. Results

Results are shown in Table 1. As a result, it was confirmed that the hamburger steak-like food containing the granular textured soybean protein containing brown rice and/or the granular soybean protein, the fibrillated granular vegetable protein, and the mixture of methyl cellulose, vegetable oil, and water had a high meat juice ratio and sufficient hardness and chewiness (Examples 1 to 3). On the other hand, in the case of the hamburger steak-like food containing the granular textured soybean protein containing brown rice and/or the granular soybean protein, and the fibrillated granular vegetable protein and separately blended with methyl cellulose, vegetable oil, and water without being in a mixture form, both of a high meat juice ratio and sufficient hardness and chewiness could not be favorably provided (Comparative Examples 1, 3, and 5). Also in the case of the hamburger steak-like food containing the granular textured soybean protein containing brown rice and/or the granular soybean protein, and the fibrillated granular vegetable protein and blended with the mixture of a granular soybean protein, vegetable oil, water, and egg white powder, both of a high meat juice ratio and sufficient hardness and chewiness could not be favorably provided (Comparative Examples 2, 4, and 6).

When the hamburger steak-like foods of Example 1 to 3 were heated and actually eaten, juicy feeling was sufficiently felt, good hardness and chewiness were obtained, and a texture close to that of a hamburger steak using a natural livestock meat was felt.

TABLE 1

| | | Comparative | Comparative | | Comparative | Comparative | | Comparative | Comparative |
|---|---|---|---|---|---|---|---|---|---|
| | Example 1 | Example 1 | Example 2 | Example 2 | Example 3 | Example 4 | Example 3 | Example 5 | Example 6 |
| Granular textured | 12.0 | 12.0 | 12.0 | 15.5 | 15.5 | 15.5 | — | — | — |
| soybean protein | | | | | | | | | |
| containing brown | | | | | | | | | |
| rice^{#1} | | | | | | | | | |
| Granular soybean | 3.5 | 3.5 | 3.5 | | | | 15.5 | 15.5 | 15.5 |
| protein^{#1} | | | | | | | | | |
| Fibrillated | 5.0 | 5.0 | 5.0 | 5.0 | 5.0 | 5.0 | 5.0 | 5.0 | 5.0 |
| granular soybean | | | | | | | | | |
| protein^{#1} | | | | | | | | | |
| Methyl cellulose^{#3} | — | 1.0 | — | — | 1.0 | — | — | 1.0 | — |
| Vegetable oil | — | 4.0 | — | — | 4.0 | — | — | 4.0 | — |
| (palm olein) | | | | | | | | | |
| Mixture of methyl | 20.0 | — | — | 20.0 | — | — | 20.0 | — | — |
| cellulose, vegetable | | | | | | | | | |
| oil, and water | | | | | | | | | |
| Mixture of granular | — | — | 21.0 | — | — | 21.0 | — | — | 21.0 |
| soybean protein, | | | | | | | | | |
| vegetable oil, | | | | | | | | | |
| water, and | | | | | | | | | |
| egg white powder | | | | | | | | | |
| Egg white powder | — | — | 1.0 | — | — | 1.0 | — | — | 1.0 |
| Water^{#3} | 37.5 | 52.5 | 37.5 | 37.5 | 52.5 | 37.5 | 37.5 | 37.5 | 37.5 |
| Onion | 12.0 | 12.0 | 10.0 | 12.0 | 12.0 | 10.0 | 12.0 | 12.0 | 10.0 |
| Cacao pigment | 0.5 | 0.5 | 0.5 | 0.5 | 0.5 | 0.5 | 0.5 | 0.5 | 0.5 |
| Vegetable oil | 7.0 | 7.0 | 7.0 | 7.0 | 7.0 | 7.0 | 7.0 | 7.0 | 7.0 |
| (palm oil) | | | | | | | | | |
| Hamburger steak | 1.0 | 1.0 | 1.0 | 1.0 | 1.0 | 1.0 | 1.0 | 1.0 | 1.0 |
| flavor | | | | | | | | | |
| Dietary salt | 0.5 | 0.5 | 0.5 | 0.5 | 0.5 | 0.5 | 0.5 | 0.5 | 0.5 |
| Spice | 0.5 | 0.5 | 0.5 | 0.5 | 0.5 | 0.5 | 0.5 | 0.5 | 0.5 |
| Yeast extract | 0.5 | 0.5 | 0.5 | 0.5 | 0.5 | 0.5 | 0.5 | 0.5 | 0.5 |
| Total (wt %) | 100.0 | 100.0 | 100.0 | 100.0 | 100.0 | 100.0 | 100.0 | 100.0 | 100.0 |
| Meat juice | 40.7 | 30.2 | 31.0 | 36.3 | 38.3 | 30.3 | 32.7 | 32.9 | 26.9 |
| ratio (%) | | | | | | | | | |
| Hardness | 251.9 | 199.4 | 274.9 | 251.7 | 163.3 | 232.9 | 301 | 262.5 | 470 |
| (gw/cm²) | | | | | | | | | |
| Chewiness | 127.7 | 101.2 | 141.5 | 115.4 | 82 | 121 | 163 | 123.4 | 252 |
| (gw/cm² · cm) | | | | | | | | | |

^{#1}“Granular textured soybean protein containing brown rice”, “Granular soybean protein”, and “Fibrillated granular soybean protein” represent a blending amount in terms of dry solid content.
#2 As “Methyl cellulose”, “Methocel Bind112” manufactured by DowDuPont was used.
^{#3}“Water” is the total value of the moisture amount contained when “Granular textured soybean protein containing brown rice”, “Granular soybean protein”, and “Fibrillated granular soybean protein” are hydrated and the moisture amount separately added.

1. A vegetable protein-containing food comprising: (A) a granular vegetable protein, and/or a granular textured vegetable protein containing brown rice; (B) a fibrillated granular vegetable protein; and (C) a mixture of fat and oil, water, and methyl cellulose.

2. The vegetable protein-containing food according to claim 1, wherein the component (A) is a granular soybean protein, and/or a granular textured soybean protein containing brown rice, and the component (B) is a fibrillated granular soybean protein.

3. The vegetable protein-containing food according to claim 1, wherein the component (A) includes both the granular vegetable protein and the granular textured vegetable protein containing brown rice.

4. The vegetable protein-containing food according to claim 3, wherein the granular textured vegetable protein containing brown rice is contained in an amount of 100 to 1900 parts by weight in terms of dry solid content per 100 parts by weight of the granular vegetable protein in terms of dry solid content.

5. The vegetable protein-containing food according to claim 1, wherein the component (C) is a mixture of 5 to 50 parts by weight of fat and oil, 30 to 92 parts by weight of water, and 3 to 20 parts by weight of methyl cellulose per 100 parts by weight of a total amount of fat and oil, water, and methyl cellulose.

6. The vegetable protein-containing food according to claim 1, wherein the component (A) is contained in an amount of 5 to 25 wt % in terms of dry solid content, the component (B) is contained in an amount of 1 to 10 wt % in terms of dry solid content, and the component (C) is contained in an amount of 10 to 80 wt %.

7. The vegetable protein-containing food according to claim 1, wherein the vegetable protein-containing food is a hamburger steak-like food.

8. A method for producing a vegetable protein-containing food, the method comprising:
a step of obtaining a mixture that contains (A) a granular vegetable protein, and/or a granular textured vegetable protein containing brown rice, (B) a fibrillated granular vegetable protein, and (C) a mixture of fat and oil, water, and methyl cellulose; and
a step of molding and heating the mixture.

9. The method according to claim 8, wherein the vegetable protein-containing food is a hamburger steak-like food.
